(19) United States
(12) Patent Application Publication
(10) Pub. No.: US 2013/0099176 A1
(43) Pub. Date: Apr. 25, 2013

(54) ELECTRODE COMPOSTION FOR INKJET PRINTING AND METHOD FOR MANUFACTURING ELECTRODE FOR DYE-SENSITIZED SOLAR CELL USING THE SAME

(71) Applicants: Yong Jun Jang, Gyeonggi-do (KR); Sang Hak Kim, Seoul (KR); Won Jung Kim, Seoul (KR); Yong Gu Kim, Gyeonggi-do (KR); Mi Yeon Song, Seoul (KR); In Woo Song, Gyeonggi-do (KR); Ji Yong Lee, Gyeonggi-do (KR); Ki Chun Lee, Seoul (KR)

(72) Inventors: Yong Jun Jang, Gyeonggi-do (KR); Sang Hak Kim, Seoul (KR); Won Jung Kim, Seoul (KR); Yong Gu Kim, Gyeonggi-do (KR); Mi Yeon Song, Seoul (KR); In Woo Song, Gyeonggi-do (KR); Ji Yong Lee, Gyeonggi-do (KR); Ki Chun Lee, Seoul (KR)

(73) Assignee: HYUNDAI MOTOR COMPANY, Seoul (KR)

(21) Appl. No.: 13/358,812

(22) Filed: Jan. 26, 2012

(30) Foreign Application Priority Data
Oct. 20, 2011 (KR) 10-2011-0107707

(51) Int. Cl. H01B 1/02; B82Y 30/00

(52) U.S. Cl. 252/514; 977/773

(57) ABSTRACT

The present invention provides an electrode composition for inkjet printing, which can be used to form an electrode having a uniform thickness on a curved substrate by inkjet printing, and a method for manufacturing an electrode for a dye-sensitized solar cell using the same. In particular, the present invention provides an electrode composition for inkjet printing, the electrode composition including about 10 to 40 wt % of platinum nanoparticles, about 1 to 10 wt % of polymer surface stabilizer, and about 40 to 89 wt % of solvent.

### CROSS-REFERENCE TO RELATED APPLICATION

This application claims under 35 U.S.C. §119(a) the benefit of Korean Patent Application No. 10-2011-0107707 filed Oct. 20, 2011, the entire contents of which are incorporated herein by reference.

### BACKGROUND

(a) Technical Field

The present invention relates to an electrode composition and a method for manufacturing an electrode for a dye-sensitized solar cell using the same. More particularly, it relates to an electrode composition for inkjet printing, which can be used to form an electrode having a uniform thickness on a curved substrate by inkjet printing.

(b) Background Art

With the increasing concerns over global warming, technology for providing and using environmentally-friendly energy has gained a lot of public attention. An attractive field, in particular, is solar cells using new and renewable energy.

Examples of such solar cells include silicon-based solar cells, thin film solar cells using inorganic substances such as copper indium gallium selenide (Cu(InGa)Se₂, CIGS), dye-sensitized solar cells, organic solar cells, organic-inorganic hybrid solar cells, etc.

Among these various types of solar cells, dye-sensitized solar cells, which are inexpensive and energy efficient at the commercial level, have attracted attention in the field of portable electronics as well as in the field of building integrated photovoltaics (BIPV).

Unlike other solar cells, dye-sensitized solar cells are provided with a solar cell system which absorbs visible light and produces electricity by a photoelectric conversion mechanism.

Typically, a patterning process is used to form a counter electrode for the dye-sensitized solar cell. In particular, the patterning process is a screen printing process using platinum.

The screen printing process is carried out by placing a screen made of mesh on a substrate, and a paste is placed on the screen and squeezed out of the screen by a squeegee. As such, the substrate is coated with the paste that passes through the patterned mesh.

However, such a screen printing process wastes expensive paste and, further, is only applicable to flat substrates. Further, it is important to control the interval between electrode patterns in solar cells because their efficiency increases when the area receiving light increases. However, the screen printing process has a limitation in controlling the interval between the electrode patterns.

In particular, in the case of a vehicle glass having a curved design, such as a sunroof, it is very difficult to uniformly coat the curved surface by the screen printing process. For example, when an electrode is coated on a curved glass by the existing screen printing process, a portion of the glass may be thickly coated while another portion may not be coated at all or may be thinly coated. This is very problematic.

For example, if the electrode is formed a non-uniform thickness, this results in a solar cell to having a non-uniform resistance. Further, the resistance of the solar cell increases, which in turn increases the resistance of the entire solar cell and reduces the efficiency of the solar cell.

In an attempt to solve such problems of the existing screen printing process, a method for forming an electrode by inkjet printing has recently been proposed. Such inkjet printing can reduce the loss of materials, can control the width of fine lines, and can be performed in a simple manner.

A patterning process using inkjet printing can be applied to curved surface devices as well as to flat panel devices and, thus, has attracted much attention as a direct printing method in various fields such as solar cells, etc.

Since the inkjet printing can directly form a desired pattern on a substrate using an inkjet head with a fine nozzle, the number of processes can be reduced, the amount of material used can be reduced, and a desired pattern can be achieved by a simple process in contrast with screen printing.

However, inkjet printing cannot use a high viscosity paste since the pattern is formed using an inkjet head with the fine nozzle.

### SUMMARY OF THE DISCLOSURE

The present invention provides an electrode composition for inkjet printing, which can be uniformly coated on a substrate by inkjet printing. In particular, in a process of manufacturing a dye-sensitized solar cell, the electrode composition forms a catalyst electrode layer having a uniform thickness on a curved substrate. The present invention further provides a method for manufacturing an electrode for a dye-sensitized solar cell using the electrode composition.

In one aspect, the present invention provides an electrode composition for inkjet printing, the electrode composition comprising platinum nanoparticles, a polymer surface stabilizer and a solvent, particularly, about 10 to 40 wt % of platinum nanoparticles; about 1 to 10 wt % of polymer surface stabilizer; and about 40 to 89 wt % of solvent.

In an exemplary embodiment, the platinum nanoparticles may have a diameter of about 5 to 50 nm.

In another exemplary embodiment, the polymer surface stabilizer may comprise at least one selected from the group consisting of polyvinylpyrolidone, polyethylene oxide-polypropylene oxide-polyethylene oxide triblock copolymer, polyethylene oxide-polypropylene oxide block copolymer, polystyrene-polyacrylic acid block copolymer, polystyrene-polyvinylpyridine block copolymer, and mixtures thereof.

In still another exemplary embodiment, the solvent may comprise at least one selected from the group consisting of ethylene glycol, methanol, ethanol, propanol, pentanol, and mixtures thereof.

In another aspect, the present invention provides an electrode for a dye-sensitized solar cell, the electrode comprising the above-described electrode composition.

In still another aspect, the present invention provides a method for manufacturing an electrode for a dye-sensitized solar cell, the method comprising: coating an electrode composition on a transparent substrate to a uniform thickness by inkjet printing; and sintering the electrode composition coated on the transparent substrate to form a catalyst electrode layer on the transparent substrate. In accordance with this aspect, the electrode composition comprises platinum nanoparticles, a polymer surface stabilizer and a solvent, particularly, about 10 to 40 wt % of platinum nanoparticles, about 1 to 10 wt % of polymer surface stabilizer, and about 40 to 89 wt % of solvent.

In an exemplary embodiment, the transparent substrate may be a curved substrate curved at a predetermined curvature.

In yet another aspect, the present invention provides an electrode for a dye-sensitized solar cell, the electrode being manufactured by the above-described method.

In still yet another aspect, the present invention provides a dye-sensitized solar cell comprising: a counter electrode comprising the above-described electrode; and a working electrode bonded to the counter electrode.

In an exemplary embodiment, the counter electrode may be coated on a curved substrate curved at a predetermined curvature.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram showing a process of manufacturing a curved counter electrode using an electrode composition for inkjet printing in accordance with an exemplary embodiment of the present invention; and

FIG. 2 is a schematic cross-sectional view showing the structure of a dye-sensitized solar cell formed of an electrode composition for inkjet printing in accordance with an exemplary embodiment of the present invention.

Reference numerals set forth in the Drawings includes reference to the following elements as further discussed below:

101: curved substrate (for counter electrode)
102: catalyst electrode layer
103: inkjet device
104: sealing agent
105: electrolyte
106: photoelectrode layer
107: curved substrate (for working electrode)

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

According to embodiments of the present invention, an electrode is formed by an inkjet printing process. Such a process provides an electrode that is uniformly formed on a curved substrate as well as on a flat substrate, which provides a uniform resistance in a solar cell module, thereby improving the efficiency of the entire solar cell module.

According to further embodiments of the present invention, an electrode composition for inkjet printing is provided which can be used in an inkjet printing process so as to form an electrode having a uniform thickness on a curved substrate as well as on a flat substrate.

Next, as the electrode composition of the present invention, a platinum ink which can be used to form an electrode having a uniform thickness on a curved substrate by an inkjet printing process will be described in detail.

According embodiments of the present invention, the platinum ink may be prepared using a platinum precursor, a polymer surface stabilizer, and a solvent.

In particular, the platinum ink of the present invention may be prepared by adding a platinum precursor solution dropwise to a surface stabilizer solution. The platinum precursor solution may be prepared by dissolving a platinum precursor in a solvent, and the surface stabilizer solution may be prepared by dissolving a surface stabilizer in a solvent. The mixture of platinum precursor solution and surface stabilizer solution are allowed to react for a predetermined time. Thereafter, a suitable additive (e.g., ethanol) is added to the mixture, and the resulting mixture is evaporated.

According to embodiments of the present invention, platinum nanoparticles are formed during the reaction of the mixed composition, and thus the platinum ink contains the thus formed platinum nanoparticles.

As such, according to embodiments of the present invention, the electrode composition for inkjet printing is a platinum ink comprising platinum nanoparticles, a polymer surface stabilizer, and a solvent.

According to embodiments of the invention, the platinum nanoparticles are not dissolved in a solvent but, rather, are contained in the platinum ink in the form of nanoparticles. In various embodiments, the platinum ink contains the platinum nanoparticles uniformly dispersed in the solvent.

Preferably, the platinum ink prepared in the above manner may comprise about 10 to 40 wt % of platinum nanoparticles, about 1 to 10 wt % of polymer surface stabilizer, and about 40 to 89 wt % of solvent. The platinum nanoparticles contained in the platinum ink may have a suitable diameter, such as a diameter of about 5 to 50 nm. Such a platinum ink makes it possible to easily form a catalyst electrode layer by an inkjet printing process.

For example, it has been found that if the platinum nanoparticles have a diameter smaller than 5 nm, then the process of forming the catalyst electrode layer by coating the platinum ink on a curved substrate takes a long time. On the other hand, if the platinum nanoparticles have a diameter greater than 5 nm, a nozzle of an inkjet head used in the inkjet printing process may become clogged, which is undesirable.

Moreover, if the amount of platinum nanoparticles is less than 10 wt %, then the amount of platinum contained in the platinum ink is too small, and thus the process of forming the catalyst electrode layer to a certain thickness by coating the platinum ink on a curved substrate takes a long time. On the other hand, if the amount of platinum nanoparticles exceeds 40 wt %, then the viscosity of the platinum ink is too high, and the nozzle of the inkjet head used in the inkjet printing process may become clogged, which is also undesirable.

It has also been found that if the amount of polymer surface stabilizer is less than 1 wt %, then the surface stability of the platinum nanoparticles is reduced, which makes it difficult to control the particle size. On the other hand, if the amount of polymer surface stabilizer exceeds 10 wt %, then the polymer surface stabilizer acts as impurities, which causes agglomeration of nanoparticles, which is undesirable.

Furthermore, if the amount of solvent is less than 40 wt %, then the viscosity of the platinum ink is relatively high, and thus the nozzle of the inkjet head used in the inkjet printing process may become clogged. On the other hand, if the amount of solvent exceeds 89 wt %, then the amount of platinum contained in the platinum ink is relatively small, and thus the process of forming the catalyst electrode layer to a certain thickness by coating the platinum ink on a curved substrate takes a long time, which is also undesirable.

Typically, metal nanoparticles tend to agglomerate, and thus it is important to prevent agglomeration and increase dispersibility. Therefore, in the present invention, the polymer surface stabilizer can be used to control the size of the platinum nanoparticles contained in the platinum ink to a desired range, such as a range of about 5 to 50 nm.

According to embodiments of the present invention, the polymer surface stabilizer may comprise at least one selected from the group consisting of polyvinylpyrolidone, polyethylene oxide-polypropylene oxide-polyethylene oxide triblock copolymer, polyethylene oxide-polypropylene oxide block copolymer, polystyrene-polyacrylic acid block copolymer, polystyrene-polyvinylpyridine block copolymer, and mixtures thereof.

Moreover, the solvent may comprise at least one selected from the group consisting of ethylene glycol, methanol, ethanol, propanol, pentanol, and mixtures thereof.

The platinum ink thus prepared may be coated on a curved substrate by the inkjet printing process to form a catalyst electrode layer having a uniform thickness.

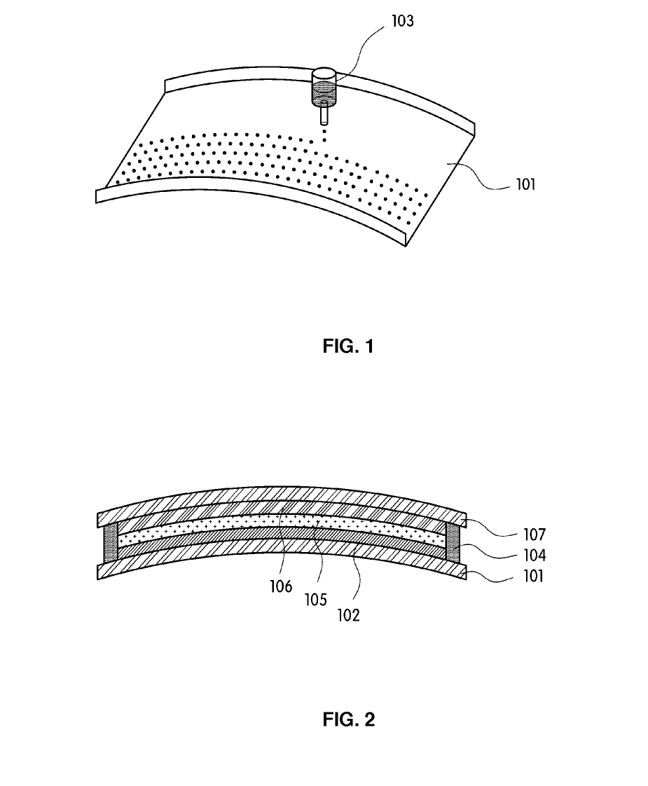

Next, a process of manufacturing an electrode (i.e., a catalyst electrode layer) for a dye-sensitized solar cell on a curved substrate using the platinum ink of the present invention will be described. First, as shown in FIG. 1, the platinum ink is coated to a predetermined thickness on one side of a curved substrate 101 that has first been coated with a fluorine-doped tin oxide (FTO) (or a curved conductive substrate) using an inkjet device 103. The coated platinum ink is then heated at a predetermined temperature and sintered at about 400° C. to 500° C., to form a catalyst electrode layer 102 for a counter electrode.

A counter electrode for a dye-sensitized solar cell can be manufactured using the curved substrate 101 coated with the catalyst electrode layer 102 formed by the inkjet printing process. Thus, for example, a curved dye-sensitized solar cell having the structure shown in FIG. 2 can be manufactured by forming a curved working electrode to be bonded to the counter electrode and then bonding the working electrode to the counter electrode.

In particular, the curved substrate 101 may be a transparent substrate curved at a predetermined curvature. Further, a flat panel solar cell may also be manufactured using a flat transparent substrate.

As such, the counter electrode with the catalyst electrode layer 102 (i.e., an electrode coating layer) can be formed by coating the platinum ink on the substrate 101 by the inkjet printing process, and the curved dye-sensitized solar cell can be manufactured using the same.

In FIG. 2, reference numeral 104 denotes a sealing agent used for the bonding of the counter electrode and the working electrode, 105 denotes an electrolyte, 106 denotes a photoelectrode layer, and 107 denotes a curved substrate for a working electrode.

Next, the process of manufacturing the dye-sensitized solar cell using the platinum ink according to the present invention will be described with reference to the following Examples, which are used to illustrate the present invention, but are not intended to limit the scope of the invention.

### Example

### Manufacture of Dye-Sensitized Solar Cell Using Platinum Ink for Inkjet Printing

A platinum chloride solution was prepared by dissolving 0.99 g of platinum chloride (H₂PtCl₆) in 5 ml of ethylene glycol, and a polyvinylpyrrolidone (PVP) solution was prepared by dissolving 0.13 g of polyvinylpyrrolidone in 10 ml of ethylene glycol. Then, the platinum chloride solution was added dropwise to the PVP solution at 110° C.

Subsequently, the resulting mixture was allowed to react for 3 hours, added with 50 ml of ethanol, and evaporated, thereby preparing a platinum ink containing platinum nanoparticles.

The thus prepared platinum ink was a composition comprising 17 wt % of platinum nanoparticles, 80 wt % of ethylene glycol, and 3 wt % of PVP.

Then, the prepared platinum ink was coated on one side of a curved glass substrate coated with a fluorine-doped tin oxide (FTO) by using an inkjet device.

The coated platinum ink was heated at 100° C. for 1 hour and sintered at 450° C. for 30 minutes, thereby forming a counter electrode with a catalyst electrode layer.

A titanium dioxide ink, as disclosed in Korean Patent Application Publication No. 10-2011-0105191, for a photoelectrode was prepared as an electrode composition for forming a photoelectrode layer. It is noted that while this particular titanium dioxide ink was used in forming the photoelectrode layer, any titanium dioxide ink could suitably be used with or without a further FTO layer which is commonly used in forming such photoelectrode layers, with minimal or no change in the properties of the dye-sensitized solar cell (as provided in Table 1).

The titanium dioxide ink for a photoelectrode was coated on a curved glass substrate using an inkjet device, heated at 100° C. for 1 hour and sintered at 500° C. for 30 minutes, thereby forming a working electrode with a photoelectrode layer.

Dye (N3, Solaronix) was adsorbed on the sintered photoelectrode layer at room temperature for 24 hours, and a porous film was immersed in an electrolyte (AN 50, Solaronix) for 12 hours.

Then, the resulting porous film was placed on the photoelectrode layer (TiO₂, a coating layer) adsorbing the dye, and the previously formed counter electrode was bonded to the working electrode using Surlyn (Dupont) at 120° C.

An electrolyte was injected between the counter electrode and the working electrode through a pre-drilled hole, and the hole was sealed with Surlyn, thereby manufacturing a dye-sensitized solar cell.

### Comparative Example

### Manufacture of Curved Dye-Sensitized Solar Cell by Screen Printing

A titanium dioxide paste (Solaronix) for screen printing was coated on one side of a curved glass substrate coated with a fluorine-doped tin oxide (FTO) using a screen printing device, and the coated titanium dioxide paste was heated at 100° C. for 1 hour and sintered at 450° C. for 30 minutes, thereby forming a counter electrode with a catalyst electrode layer.

Then, a titanium dioxide paste (Solaronix) for screen printing was coated on one surface of a curved glass substrate coated with a fluorine-doped tin oxide (FTO) using a screen printing device, and the coated titanium dioxide paste was heated at 100° C. for 1 hour and sintered at 500° C. for 30 minutes, thereby forming a working electrode with a photoelectrode layer.

Dye (N3, Solaronix) was adsorbed on the formed photoelectrode layer at room temperature for 24 hours, and a non-porous film was immersed in an electrolyte (AN 50, Solaronix) for 12 hours.

Then, the resulting non-porous film was placed on the photoelectrode layer having the adsorbed dye, and the previously formed counter electrode was bonded to the working electrode using Surlyn (Dupont) at 120° C.

An electrolyte was injected between the counter electrode and the working electrode through a pre-drilled hole, and the hole was sealed with Surlyn, thereby manufacturing a dye-sensitized solar cell.

Electrochemical properties measured from the curved dye-sensitized solar cells manufactured in the Example and the Comparative Example are shown in the following Table 1.

TABLE 1

| | Current | | Fill | Energy |
|---|---|---|---|---|
| | density | Voltage | factor | conversion |
| Samples | (Jsc) | (Voc) | (FF) | efficiency (%) |
| Example | 3.743 | 0.657 | 45.5 | 1.12 |
| Comp. Example | 3.576 | 0.613 | 22.0 | 0.48 |

As can be seen from Table 1, the current density and energy conversion efficiency of the dye-sensitized solar cell manufactured by coating the platinum ink containing platinum nanoparticles by inkjet printing in accordance with the present invention (the Example) were improved compared to those of the dye-sensitized solar cell manufactured by coating the high-viscosity paste by screen printing in the Comparative Example.

As described above, the electrode composition for inkjet printing according to the present invention can be coated on a curved substrate by an inkjet printing process to form a catalyst electrode layer having a uniform thickness. Therefore, the curved dye-sensitized solar cell with the thus formed catalyst layer has at least an equivalent level of performance to the dye-sensitized solar cell manufactured by coating the existing electrode paste on a curved substrate by screen printing.

As a result, it is possible to reduce the overall resistance of the curved dye-sensitized solar cell and increase the fill factor, thereby increasing the efficiency of the solar cell.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. An electrode composition for inkjet printing, the electrode composition comprising:
about 10 to 40 wt % of platinum nanoparticles;
about 1 to 10 wt % of polymer surface stabilizer; and
about 40 to 89 wt % of solvent.

2. The electrode composition of claim 1, wherein the platinum nanoparticles have a diameter of about 5 to 50 nm.

3. The electrode composition of claim 1, wherein the polymer surface stabilizer comprises at least one selected from the group consisting of polyvinylpyrolidone, polyethylene oxide-polypropylene oxide-polyethylene oxide triblock copolymer, polyethylene oxide-polypropylene oxide block copolymer, polystyrene-polyacrylic acid block copolymer, polystyrene-polyvinylpyridine block copolymer, and mixtures thereof.

4. The electrode composition of claim 1, wherein the solvent comprises at least one selected from the group consisting of ethylene glycol, methanol, ethanol, propanol, pentanol, and mixtures thereof.

5. An electrode for a dye-sensitized solar cell, the electrode comprising the electrode composition of claim 1.
